(19) United States
(12) Patent Application Publication
(10) Pub. No.: US 2016/0023434 A1
(43) Pub. Date: Jan. 28, 2016

(54) PROCESS FOR THE PRODUCTION OF A THERMOPLASTIC FOAM SHEET VIA SYMMETRICAL BONDING OF THE INPUT SHEETS

(71) Applicant: BASF SE, Ludwigshafen (DE)

(72) Inventors: Dietrich SCHERZER, Neustadt (DE); Klaus HAHN, Kirchheim (DE); Christoph HAHN, Neustadt (DE); Tim DIEHLMANN, Obrigheim-Colgenstein (DE); Peter MERKEL, Zellertal (DE); Franz-Josef DIETZEN, Hassloch (DE); Carsten SANDNER, Bad Durkheim (DE); Cathrin SCHRÖDER, Mannheim (DE); Maria-Kristin SOMMER, Wachenheim (DE)

(21) Appl. No.: 14/669,162

(22) Filed: Mar. 26, 2015

(30) Foreign Application Priority Data
Mar. 28, 2014 (EP) 14162287.8

(51) Int. Cl. B32B 5/32; B32B 7/12; B29C 47/00

(52) U.S. Cl. CPC B32B 5/32; B29C 47/0042; B29C 47/0064; B32B 7/12; B29K 2025/04

(57) ABSTRACT

A process for the production of an at least two-layer thermoplastic foam sheet via symmetrical bonding, e.g., by thermal welding, of at least two thinner thermoplastic foam sheets to give the at least two-layer thermoplastic foam sheet. The invention further relates to thermoplastic foam sheets having at least two layers. The number of the layers of the thermoplastic foam sheet derives from the number of thin thermoplastic foam sheets that are thermally welded to one another.

### CROSS REFERENCE TO RELATED APPLICATION

This application claims priority to European Application No. 14162287.8, filed Mar. 28, 2014, which is incorporated herein by reference in its entirety.

The present invention relates to a process for the production of at least two-layer thermoplastic foam sheets via symmetrical bonding of at least two thinner thermoplastic foam sheets to give the at least two-layer thermoplastic foam sheet. It is preferable that the thermoplastic foam sheets of the present invention and the thinner thermoplastic input sheets used therefor are extruded thermoplastic foam sheets. The symmetrical bonding preferably takes place via (symmetrical) thermal welding. The present invention further relates to the thermoplastic foam sheets per se, these having at least two layers. The number of the layers of the thermoplastic foam sheet per se derives from the number of the thinner thermoplastic foam sheets that are thermally welded to one another. If, by way of example, three thinner thermoplastic foam sheets are thermally welded to one another, the product per se is a three-layer thermoplastic foam sheet, and if four thinner thermoplastic foam sheets are used the product is accordingly per se a four-layer thermoplastic foam sheet.

### BACKGROUND OF THE INVENTION

A problem that frequently arises with thermoplastic foam sheets, in particular with extruded thermoplastic foam sheets, is that they are susceptible to subsequent deformation caused by temperature changes. This deformation is also termed “arching” or “thermally induced warpage”. The thermally induced warpage of (extruded) thermoplastic foam sheets is caused by inhomogeneity in the structure of the sheet, leading to different stresses on the respective sides of the sheet during changes in temperature, in particular during heating. Warpage or deformation of the (extruded) thermoplastic foam sheet is observed as a consequence of these temperature changes, in particular during heating.

In the case of a continuous extrusion process, for example, the extruded thermoplastic foam is discharged from the extruder through the extrusion die, and is generally shaped by, or subjected to the effect of, a calibrator. By way of example, the effect of gravity during discharge of the thermoplastic foam from the extrusion die in the continuous extrusion process produces regions of different density, and therefore inhomogeneity in the sheet structure, in the resultant extruded thermoplastic foam sheets. These regions of different density or “frozen-in stresses” finally result in the thermally induced warpage during changes of temperature. Said density differences result by way of example from foam structure differences caused by the effects of gravity on the external sides of the sheets, from differences in cooling rates of the external sides of the sheets, or from variations in orientations of the extruded polymers at the external sides of the sheets. Temperature change causes warpage (of the shape) of the extruded thermoplastic foam sheets to the extent that these have density differences resulting, for example, from one of the abovementioned causes. Regions with a high density exhibit high thermally induced stress and correspondingly undergo greater deformation during temperature increase than regions with a lower density representing lower thermally induced stress.

The production of extruded thermoplastic foam sheets via continuous extrusion of thermoplastic polymers has already been known for some time. The fundamental steps in a process for the production of, for example, an extruded polystyrene foam (XPS) are disclosed inter alia in “Polystyrol, Kunststoffhandbuch 4” [Polystyrene, Plastics handbook 4] [H. Gausepohl and R. Gellert, Hanser-Verlag, Munich (1996)), chapter 13.2.3 (pp. 591-598). Products (such as extruded thermoplastic foam sheets or foils) with uniform properties are obtained by homogenizing the melt, for example by using static or dynamic mixers upstream of the die, i.e. in the extruder. However, these measures cannot suppress arching of extruded thermoplastic foam sheets caused by exposure to heat.

EP-A 2 420 531 discloses extruded foams based on a polymer such as polystyrene, comprising at least one mineral filler with particle size ≦10 μm and at least one nucleating agent. These extruded foams can also take the form of foam sheets. The simultaneous addition of the mineral filler with a specific particle size and of at least one nucleating agent based on a wax or an oligomer gives the extruded foams of EP-A 2 420 531 improved stiffness. However, EP-A 2 420 531 does not describe the problem of arching of thermoplastic foam sheets due to exposure to heat, i.e. of thermally induced warpage.

EP-A 0 543 242 relates to a process for the production of foam sheets with high compressive strength via extrusion of a mixture of a styrene polymer and a blowing agent. EP-A 0 427 533 discloses dimensionally stable alkenylaromatic polymer foams which are likewise produced via extrusion. The respective inventive examples in both documents subject the appropriately produced single-layer extruded foam sheets to various test methods for testing of dimensional stability. However, neither of these documents discloses multilayer, i.e. at least two-layer, thermoplastic foam sheets or testing of dimensional stability thereof.

EP-A 1 318 164 relates to a process for the production of thick extruded polystyrene foam sheets (XPS sheets) via bonding of two or more thin sheets. The thick sheets are obtained by using an organic solvent that dissolves polystyrene for uniform wetting of the thin sheets on the areas where they are to be bonded. This causes incipient dissolution of the foam surface, and the sheets can then together be subjected to a pressing process. Examples of suitable solvents are hydrocarbons, alcohols, or ethers, where the boiling point of these is from 50 to 250° C. In the process of EP-A 1 318 164 it is moreover possible that the foaming skins on the main areas of the sheets to be bonded to one another are peeled away before they are wetted with the solvent.

EP-A 1 213 119 discloses a process for the bonding of at least two input sheets made of thermoplastic foam to give a new sheet, where the input sheets are extrusion-skin-free at the contact areas, and the bonding of the input sheets takes place via solvent welding. The solvent welding process uses organic solvents with boiling point <150° C., for example acetone or a mixture of organic solvents with water.

DE-A 101 063 41 discloses extruded plastics foam sheets of high thickness. The process described therein for the bonding of at least two input sheets made of plastics foam to give a new sheet can produce sheets with a minimal thickness of 70 mm. Preference is given here to fluorochlorocarbon-free polystyrene foam sheets. The input sheets, which are extrusion-skin-free on the contact area, are bonded to one another in the process by use of an adhesive that does not prevent diffusion, or of mechanical bonding elements. Alternatively, in the event of partial-area bonding and local welding, or local adhesive bonding, the process can also be carried out with use of an adhesive not amenable to diffusion, or an adhesive amenable to only a low level of diffusion. Particularly suitable polystyrene foam sheets are XPS sheets. However, DE-A 101 063 41 comprises no information about any specific method for the welding, instead of adhesive bonding, of the input sheets.

WO 2012/016991 describes thermal insulation materials made of XPS composite materials, where these have three layers. The source of the three layers of the composite materials is the combination of a lower, a central, and an upper XPS sheet to give the XPS composite material, and each externally oriented side of said XPS composite material comprises an extrusion skin. The contact sides of the central XPS sheet likewise have an extrusion skin, but in the case of the corresponding contact sides of the upper, and also lower, XPS sheet this skin is removed. The individual XPS sheets are joined via thermal welding at the contact areas to give the XPS composite material. The thermal welding preferably uses a heating rod, and also preferably uses direct contact of the heating rod with the XPS sheets to be welded, via movement of the XPS sheets over a rigidly arranged heating rod. The weld formed between the individual XPS sheets can have subregions of different intensity, and this means that the corresponding weld is relatively strong at some locations, and by contrast relatively weak at other locations.

### SUMMARY OF THE INVENTION

The object underlying the present invention consists in the provision of at least two-layer thermoplastic foam sheets which have higher thermal stability.

The object is achieved via a process for the production of an at least two-layer thermoplastic foam sheet via symmetrical bonding of at least two thinner thermoplastic foam sheets to give the at least two-layer thermoplastic foam sheet.

A feature of the at least two-layer thermoplastic foam sheets of the invention is that they exhibit no arching, or only a reduced extent of arching, as a consequence of exposure to heat. In other words, the at least two-layer thermoplastic foam sheets of the invention preferably exhibit no, or only reduced, thermally induced warpage. The at least two-layer thermoplastic foam sheets of the invention are moreover also stable in storage.

Another feature of the at least two-layer thermoplastic foam sheets produced by the process of the invention via symmetrical bonding is that the inhomogeneity arising within the individual regions of the sheets when the input sheets are subjected to conventional production processes, for example a continuous extrusion process, are suppressed or minimized by virtue of the symmetrical bonding of the input sheets. The inhomogeneity in the input sheets arises in particular because of asymmetry or temperature differences, or because of the effect of gravity during the discharge of the thermoplastic foam input sheets from the extrusion die during the extrusion step. The process of the invention comprising symmetrical bonding of the input sheets eliminates stresses of this type that are frozen into the respective input sheets in conventional continuous extrusion processes. When the at least two-layer thermoplastic foam sheets produced by the processes of the invention are subjected to heat treatment, they therefore exhibit no, or only markedly reduced, thermally induced warpage, where the maximal deformation is ≦1.5 mm (based on the respective thickness of the thermoplastic foam sheet (in z-direction).

### BRIEF DESCRIPTION OF THE DRAWINGS

FIG. 1 illustrates a spatial arrangement of length, width, and thickness of an at least two-layer thermoplastic foam sheet of the invention.

FIG. 2 illustrates thermally induced warpage of an at least two-layer thermoplastic sheet, where,

FIG. 2A is a side view of an at least two-layer thermoplastic foam sheet before exposure to a heat source; and

FIG. 2B depicts the same at least two-layer thermoplastic foam sheet after exposure to a heat source.

### DETAILED DESCRIPTION OF THE INVENTION

For the purposes of the present invention, the meaning of the expression “symmetrical bonding” is as follows: the symmetrical bonding process in each case bonds two thinner thermoplastic foam sheets (input sheets) to one another which have in principle been produced in the same manner (i.e. identical process and/or apparatus). The respective identical sides of the input sheets are placed here in such a way that they cover one another. This means that by way of example two upper sides or two lower sides of the respective input sheets are bonded to one another, thus achieving the symmetry (“an orientation of the input sheets”). In this way, any regions of higher density in each of the sheets or any regions of low density in each of the sheets are placed in such a way that they cover one another. However, it is optionally possible that the individual input sheets differ in respect of specific chemical composition and/or in respect of specific dimensioning (for example in respect of their thickness (z-direction)). It is preferable, however, that the two input sheets of a pair of sheets are identical in respect of chemical composition and/or of dimensioning.

To the extent that the process of the invention produces thermoplastic foam sheets having three or even more layers, at least one pair of sheets (i.e. a two-layer region) has been produced via symmetrical bonding of at least two input sheets. It is preferable that in the case of thermoplastic foam sheets having three or more layers all of the input sheets have been produced via symmetrical bonding.

The symmetrical bonding process therefore differs from conventional bonding in particular in that the symmetrical bonding process takes into account the orientation of the input sheets. The bonding per se can in principle be carried out by any of the processes known to the person skilled in the art that are suitable for the bonding of input sheets, for example adhesive bonding or thermal welding.

Definitions providing greater detail of the at least two-layer thermoplastic foam sheets of the invention per se, and also of the production process of the invention for said foam sheets via symmetrical bonding, are provided below.

The thermoplastic foam sheet of the invention has at least two layers, and it can therefore have precisely two layers or have three, four, five, or even more layers. As already stated above, the number of the layers of the thermoplastic foam sheet per se results from the number of the thinner thermoplastic foam sheets symmetrically bonded to one another. The thin thermoplastic foam sheets are also called input sheets. In the case of a two-layer thermoplastic foam sheet per se, therefore, two thinner thermoplastic foam sheets are symmetrically bonded to one another. In the case of a three- or four-layer thermoplastic foam sheet per se, therefore, three or, respectively, four thinner thermoplastic foam sheets are preferably symmetrically bonded to one another. Insofar as thermoplastic foam sheets per se having an even larger number of layers are to be produced, an example being a ten-layer thermoplastic foam sheet, it is accordingly necessary that the number of thinner thermoplastic foam sheets preferably symmetrically bonded to one another corresponds to the number of the layers, an example being ten thinner thermoplastic foam sheets. It is preferable that the thermoplastic foam sheet of the invention has two layers or three layers, and in particular the thermoplastic foam sheet of the invention has two layers.

In the case of thermoplastic foam sheets having three or more layers it is preferable that the individual layers are assembled stepwise. In the case of a three-layer thermoplastic foam sheet it is therefore preferable that the product of the first step (i.e. the two-layer thermoplastic foam sheet) is used as first thinner input sheet and bonded to another thinner input sheet, where said other (second) thinner input sheet can be identical with or different from (in particular in respect of its thickness) the first thinner input sheet of the second step.

The thinner thermoplastic foam sheets used for the symmetrical bonding process, preferably for the symmetrical thermal welding process, correspond in respect to their chemical composition to the at least two-layer thermoplastic foam sheets per se produced in the context of the process of the invention (ignoring the components optionally applied to the surfaces by way of example in the context of the welding procedure, for example absorbers of electromagnetic radiation or binders, and ignoring the chemical changes/reactions arising as a consequence of the formation of the weld on the corresponding surfaces, or in the case of adhesive bonding ignoring the adhesives used).

It is preferable that the respective thinner thermoplastic foam sheets to be bonded symmetrically to one another have the same dimensions and/or the same chemical composition. However, it is also possible optionally that thermoplastic foam sheets with different dimensions and/or different chemical composition are thermally welded to one another. If, by way of example, three thinner thermoplastic foam sheets are bonded symmetrically to one another, all of which have the same dimensions and (by way of example) are an extruded polystyrene foam (XPS foam), the resultant product is a three-layer extruded thermoplastic polystyrene foam (XPS).

The thinner thermoplastic foam sheets to be symmetrically bonded to one another can have any desired dimensions. In respect of their length and width they can have dimensions from the centimeter range up to a number of meters. In respect of the third dimension (thickness), any desired dimensions are theoretically likewise possible, but in practice the thickness of the thinner thermoplastic foam sheets is from 10 to 150 mm. The thickness of the at least two-layer thermoplastic foam sheets produced in the process of the invention therefore results from the total thickness of all of the thinner thermoplastic foam sheets (input sheets) used. It is by way of example possible, however, in the case of the thermal welding, that the respective input-sheet surfaces to be welded to one another are at least to some extent melted or incipiently melted (melting step), and this can lead to a certain reduction of the thickness of the respective input sheet, depending on the quantity of heat introduced. At the sites where the input sheets are thermally welded to one another a weld is formed. In particular when a lamination and/or melting step where a large amount of heat is introduced is carried out in the context of the production process, the thickness of the at least two-layer thermoplastic foam sheets per se is smaller than the sum of the respective thicknesses of the thinner thermoplastic foam sheets used.

The thinner thermoplastic foam sheets per se used for the symmetrical bonding process are in principle known to the person skilled in the art. Suitable thermoplastic foam sheets are disclosed by way of example in EP-A 1 566 490 or in the form of blends in WO 2009/047487. By way of example, it is possible to use sheets made of amorphous, crystalline, or semicrystalline thermoplastic foams.

It is preferable that the thinner thermoplastic foam sheets are a molded foam or an extruded foam. It is moreover preferable that the density of the thinner thermoplastic foam sheets is <200 g/l, preferably <100 g/l. A preferred molded foam is Styropor®, which is obtainable commercially from BASF SE. It is more preferable that the thinner thermoplastic foam sheets are an extruded foam. It is preferable that the extruded foam is a polystyrene or a copolymer produced from styrene. Mixtures of polymers of this type can optionally also be used. It is particularly preferable that the extruded foam is extruded polystyrene (XPS), which by way of example is obtainable commercially as Styrodur® from BASF SE.

Insofar as the extruded foam is based on (at least) a copolymer produced from styrene (these also being known as styrene copolymers), this means that the production of said copolymer requires at least one other monomer alongside the styrene monomer. It is preferable that said copolymer is produced from styrene and from one other monomer. Suitable comonomers for styrene are in principle any of the monomers polymerizable with styrene. It is preferable that there is at least 50% by weight of styrene incorporated by polymerization within said copolymer.

It is preferable that a copolymer produced from styrene has, as comonomer for the styrene, a monomer selected from a-methylstyrene, ring-halogenated styrenes, ring-alkylated styrenes, acrylonitrile, acrylate, methacrylate, N-vinyl compounds, maleic anhydride, butadiene, divinylbenzene, or butanediol diacrylate. Acrylates and methacrylates are preferably obtainable from alcohols having 1 to 8 carbon atoms. An example of a suitable N-vinyl compound is vinylcarbazole. Preferred copolymers produced from styrene are styrene-acrylonitrile copolymers (SAN) or acrylonitrile-butadiene-styrene copolymers (ABS).

As already stated above, the symmetrical bonding used in the process of the invention for the input sheets differs from conventional bonding techniques in that the positioning (symmetry) of the input sheets relative to one another must be taken into account in the process of the invention. The symmetrical bonding process can in principle be applied to any of the bonding techniques already known, for example solvent welding, adhesive bonding, or thermal welding of the appropriate input sheets. It is preferable that the symmetrical bonding in the process of the invention takes place via symmetrical adhesive bonding and/or via symmetrical thermal welding, in particular via symmetrical thermal welding.

It is moreover preferable in the invention that the symmetrical bonding where at least one pair of sheets is to be bonded comprises bonding either two upper sides or two lower sides of the respective thinner thermoplastic foam sheets to one another.

It is moreover preferable in the process of the invention that in the symmetrical bonding where at least one pair of sheets is to be bonded, the density of the respective surfaces to be bonded of the two thinner thermoplastic foam sheets is identical or differs by at most 20%, preferably by at most 10%, more preferably by at most 5%. It is particularly preferable that the density of all of the surfaces to be bonded of the respective (thinner) input sheets is identical.

Insofar as the symmetrical bonding carried out in the process of the invention is symmetrical adhesive bonding, the method known to the person skilled in the art is used to carry out the adhesive bonding procedure per se and to select suitable adhesives. The German patent application DE-A 10 2012 023 180.6 discloses by way of example an appropriate adhesive process, and also suitable adhesives.

Insofar as the symmetrical bonding carried out in the process of the invention is symmetrical thermal welding, the conduct per se of the thermal welding is known to the person skilled in the art. The effect of the symmetrical thermal welding process is achieved for the surfaces to be welded by exposing the respective surfaces to a heat source. The appropriate heat sources or apparatuses are known to the person skilled in the art. It is preferable that the thermal welding is carried out with an apparatus selected from a heating rod, a heating grid, or a heating plate, where the apparatus can optionally have bumps or grooves. By way of example, the thermal welding can be carried out continuously with use of a heating rod, but it is equally possible to carry out a hotplate welding process with use of a heating plate or a heating grid. Insofar as the appropriate apparatus for the thermal welding has bumps or grooves, this also permits application of structured depressions to the appropriate surface of the thinner thermoplastic foam sheets that are to be thermally welded. Within the context of the present invention it is also possible that the thermal welding, i.e. the heat-introduction process, is carried out to some extent or entirely with use of electromagnetic radiation instead of use of an apparatus such as a heating rod or a heating grid (see also the text at a later stage below). It is equally conceivable that there is an additional welding step with use of electromagnetic radiation downstream of the thermal welding using a heating rod or a heating grid.

The symmetrical thermal welding process forms a weld between the surfaces to be welded. Other terms that can also be used instead of the term “weld” are “weld skin” or “weld zone”. At the sites where the surface of the thinner thermoplastic foam sheet optionally has structured depressions, it is preferable that the thermal welding in the context of the present invention does not form any weld. At the sites where a weld is formed, the thickness of the weld can be as desired. The weld preferably measures from 30 to 200 μm (average value determined via optical microscopy from at least five measurement points), more preferably from 50 to 150 μm, still more preferably from 70 to 150 μm, in particular form 80 to 130 μm. It is preferable that the welding procedure takes place over a period of at most 10 seconds (based on the respective sites on a surface to which energy is introduced).

The symmetrical thermal welding process in the invention is carried out at temperatures of from 150° C. to 400° C., preferably with heating to temperatures above the glass transition temperature and/or melting point of the thermoplastic foam sheet. It is preferable that the symmetrical thermal welding is carried out at temperatures of from 50 to 300° C. above the glass transition temperature in the case of amorphous thermoplastic foams or of from 50 to 100° C. above the melting point in the case of semicrystalline thermoplastic foams.

In one embodiment of the present invention, the symmetrical thermal welding process takes place in the presence of at least one absorber of electromagnetic radiation (also termed “absorber” in the text below). To this end, at least one absorber is applied to at least one surface of at least one thinner thermoplastic foam sheet.

It is preferable that, for each pair of sheets to be welded, application of at least one absorber of electromagnetic radiation takes place onto only one surface to be symmetrically thermally welded of the thinner thermoplastic foam sheets. Processes for the application of the absorber of electromagnetic radiation are known to the person skilled in the art, and by way of example the absorber can be applied to a large surface area of the appropriate surface of the thinner thermoplastic foam sheet. It is preferable that the absorber of electromagnetic radiation is used in the form of dispersion, in particular in the form of aqueous dispersion. The method of application to the surface of the sheet can by way of example be brushing, doctoring, rolling, spraying, or printing.

The quantity of absorber (solids) on a surface is normally from 0.01 g/m² to 100 g/m², preferably from 0.1 g/m² to 50 g/m², particularly preferably from 1 g/m² to 20 g/m². The absorbers can be applied on one side or on both sides.

Absorbers of electromagnetic radiation per se are known to the person skilled in the art. WO 2006/050013, WO 99/47621, and WO 012/1725 describe suitable susceptors for radio-frequency radiation. Preferred susceptors are polymeric ionomers.

Pages 9 to 11 of WO 2009/071499 by way of example describe absorbers of other types of radiation. In the context of the present invention it is preferable that the absorber of electromagnetic radiation is selected as required by the electromagnetic radiation used for the thermal welding. If, by way of example, the thermal welding uses microwave radiation, it is preferable to select an absorber of electromagnetic radiation that has good absorption capability in the microwave wavelength range.

Examples of suitable absorbers are organic IR absorbers, organic microwave absorbers, inorganic IR absorbers, or inorganic microwave absorbers.

In the context of this application, the expression IR absorber means a compound which exhibits ≧90% absorption at at least one wavelength of radiation in the wavelength range from 700 nm to 1000 μm when applied in a layer thickness of ≦50 μm. The wavelength range is preferably from >1 μm to 20 μm.

In the context of this application, the expression microwave absorber means a compound which absorbs microwaves in the wavelength range from >1 mm to 1 m. Particular preference is given to the technically relevant frequencies of 2.45 GHz, 433-444 MHz, and 902-928 MHz.

It is preferable that the absorber of electromagnetic radiation is an infrared (IR) absorber and/or microwave absorber, in particular graphite or carbon black. It is moreover preferable that the electromagnetic radiation is IR radiation and/or microwave radiation.

Insofar as at least one absorber of electromagnetic radiation is applied in the context of the present invention to at least one surface of at least one thinner thermoplastic foam sheet, it is preferable that the symmetrical thermal welding takes place to some extent or entirely with use of electromagnetic radiation. The person skilled in the art is familiar with the equipment required for the generation of the electromagnetic radiation suitable for this purpose. By way of example, it is possible to irradiate a coated sheet for a number of seconds to minutes in a microwave oven or by using an IR source.

In one preferred embodiment of the present invention, at least one absorber of electromagnetic radiation is applied to at least one surface of at least one thinner thermoplastic foam sheet, and at least one thinner thermoplastic foam sheet to which the absorber of electromagnetic radiation has been applied is irradiated with electromagnetic radiation.

As already mentioned above it is possible to apply, to the surface to be welded of the appropriate thinner thermoplastic foam sheets, not only the absorber of electromagnetic radiation but also other substances with other usage properties, together with the absorber. Suitable other substances can be by way of example binders, flame retardants, pH regulators, and also optionally solvents. Binders, flame retardants, pH regulators, and also solvents are known per se to the person skilled in the art.

In one embodiment of the present invention a mixture is applied to at least one surface of at least one thinner thermoplastic foam sheet, and comprises i) at least one absorber of electromagnetic radiation, ii) at least one binder, and/or iii) at least one flame retardant.

Suitable binders in the context of the present invention are selected from polyacrylates and copolymers thereof, polystyrene and copolymers thereof, ethylene/acrylate copolymers, ethylene/vinyl acetate copolymers, polyurethanes, and polyurethane/acrylate hybrids. Preferred copolymers of polystyrene are styrene/butadiene copolymers.

Preferred binders are selected from aqueous dispersions or solutions of polyacrylates and copolymers thereof, polystyrene and copolymers thereof, ethylene/acrylate copolymers, ethylene/vinyl acetate copolymers, polyurethanes, and polyurethane/acrylate hybrids. Preferred copolymers of polystyrene are styrene/butadiene copolymers.

Particularly preferred binders are dispersions with high content of polystyrene or copolymers thereof, in particular with high content of polystyrene. These dispersions are preferably used when the thinner thermoplastic foam sheets (input sheets) in the process of the invention likewise comprise polystyrene or copolymers thereof, because by virtue of the use of said binder there is even less difference between the properties of the at least two-layer thermoplastic foam sheets (composite sheets) and those of the input sheets.

In one embodiment of the present invention, the thermoplastic foam sheets of the invention comprise at least one flame retardant. Flame retardants per se are known to the person skilled in the art. Preferred flame retardants in the context of the present invention are selected from a phosphate, a phosphite, a phosphonate, a polyphosphonate, melamine, a metal oxide hydrate, in particular an aluminum oxide hydrate, or a halogenated organic compound. The abovementioned flame retardants, preferably the phosphorus-containing flame retardants, but not the halogenated organic compounds, are preferably applied before the thermal welding, directly to at least one surface (per pair of sheets) of the input sheets to be welded.

Preferred phosphates and phosphonates are selected from DMMP (dimethyl methylphosphonate), DMPP (dimethyl propylphosphonate), TCEP (tris(chloroethyl) phosphate), TCPP (tris(chloropropyl) phosphate), TDCPP (tris(dichloroisopropyl) phosphate), TPP (triphenyl phosphate), TEHP (tris(2-ethylhexyl) phosphate), TCP (tricresyl phosphate) or TCEP (trichloropropyl phosphate).

Preferred halogenated organic compounds are bromine-containing organic compounds, particular preference being given to HBCD (hexabromocyclododecane) or brominated polystyrenes. Brominated polystyrenes are obtainable commercially, for example Emerald from Great Lakes. Quantities preferably used of these are from 0.5 to 5% by weight (based on the input sheet). Insofar as halogenated organic compounds are used as flame retardants, this use preferably takes place before the process for production of the input sheets is completed, and this means that the flame retardant has uniform distribution over the entire thickness of the respective input sheet.

A particularly preferred flame retardant is dimethyl propylphosphonate (DMPP), which is by way of example obtainable commercially as Levagard DMPP from Lanxess. In one embodiment of the present invention preference is given to expandable graphite, which likewise can be used as absorber.

As already stated above, the dimensions of the at least two-layer thermoplastic foam sheets per se produced in the process of the invention are based on the appropriate dimensions of the input sheets used in said process. In principle, the dimensions of the at least two-layer thermoplastic foam sheets can be as desired. It is preferable that the at least two-layer thermoplastic foam sheet is an at least two-layer thermoplastic foam sheet whose thermally induced warpage is ≦1.5 mm, based on the thickness of the at least two-layer thermoplastic foam sheet. It is particularly preferable that it is an at least two-layer extruded thermoplastic foam sheet whose thermally induced warpage is preferably ≦1.5 mm, based on the thickness of the at least two-layer extruded thermoplastic foam sheet.

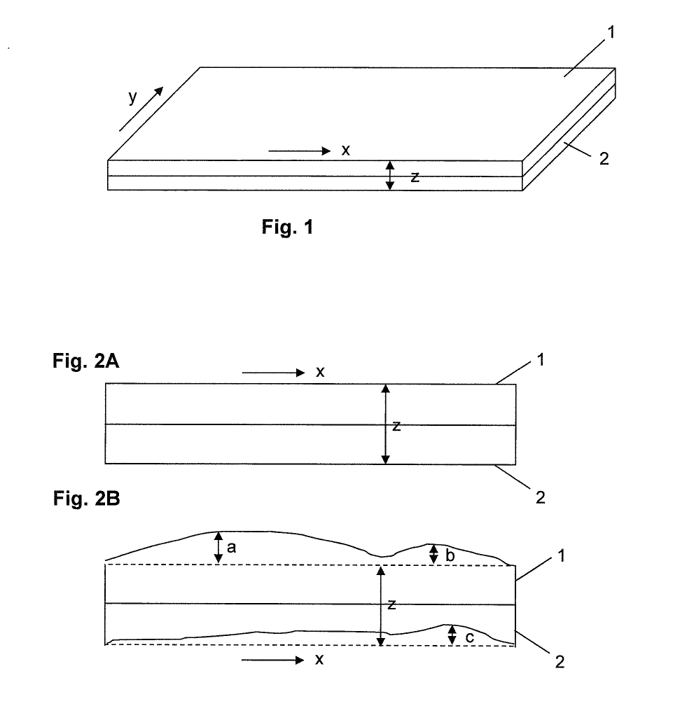

It is preferable in the invention that the thermally induced warpage is 5 1.5 mm, based on the thickness of the thermoplastic foam sheets, preferably the extruded thermoplastic foam sheets. FIG. 1 illustrates the spatial arrangement of length, width, and thickness of an at least two-layer thermoplastic foam sheet of the invention with reference to a two-layer extruded thermoplastic foam sheet. The numerals 1 and 2 here respectively represent a thinner thermoplastic input sheet which, via symmetrical bonding in the invention, preferably via symmetrical thermal welding, has been placed in such a way as to cover another sheet to form the two-layer thermoplastic foam sheet per se.

In the invention the thickness is defined as the z-direction, which together with the x-direction and the y-direction define the dimensions of the at least two-layer thermoplastic foam sheets of the invention in a rectangular coordinate system. In the invention the x-direction means the length of the at least two-layer thermoplastic foam sheets and the y-direction means the width of these sheets. The length (x-direction) is defined in the case of the continuous extrusion process by the extrusion direction. The length of the at least two-layer thermoplastic foam sheets in the invention is always greater than the width and the thickness. It is preferable in the at least two-layer thermoplastic foam sheets of the invention that the length (x-direction) is greater than the width (y-direction) and that in turn the width is greater than the thickness (z-direction).

The thermally induced warpage (also termed deformation or arching) is based in the invention on the thickness of the at least two-layer thermoplastic foam sheets (z-direction), which is preferably the smallest of the three dimensions. The thermally induced warpage in the invention is ≦1.5 mm, preferably <1.0 mm, more preferably <0.5 mm, and in particular no thermally induced warpage occurs at all. The expression “no thermally induced warpage” in the invention means deformation of from 0 to at most 0.1 mm in z-direction.

It is particularly preferable that the abovementioned limiting values for thermally induced warpage still apply even after heat treatment in the range from 40 to 70° C. from seven to ten days.

FIG. 2 illustrates the thermally induced warpage, and in FIG. 2A here a side view of an at least two-layer thermoplastic foam sheet before exposure to heat can be seen. FIG. 2B depicts the same at least two-layer thermoplastic foam sheet after this has been exposed to a heat source. Temperature changes (heat treatment) have caused visible arching (deformation in z-direction). The distance a in FIG. 2B depicts the (maximal) distension or the warpage (arching) in z-direction. The broken lines indicate the shape of the at least two-layer thermoplastic foam sheet before the heat treatment. The distances b and c likewise indicate sites where arching has taken place, but to a somewhat smaller extent in comparison with the site defined by the distance a.

The thermally induced warpage is determined in the invention by storing the corresponding at least two-layer thermoplastic foam sheet for a period of from 10 to 20 hours at at most 70° C. It is preferable that the test is carried out at at most 72 hours after the production process and is carried out at 60° C. for 12 hours. The maximal deviation of the at least two-layer thermoplastic foam sheets of the invention caused by the heat treatment described above in z-direction (thickness), i.e. the distance a in FIG. 2B, is 1.5 mm. It is moreover preferable that the thermally induced warpage of the at least two-layer thermoplastic foam sheets of the invention is constant at ≦1.5 mm for a period of at least one week. The test to determine the specific values of the thermally induced warpage can use a simple method with a leveling rod placed horizontally on the appropriate surface; a microscope can optionally also be used to determine deviations.

It is preferable that in the symmetrical bonding, in the case of at least one pair of sheets to be bonded, the length (x-direction) of the two thinner thermoplastic foam sheets is respectively from 500 to 2800 mm, preferably from 1000 to 1500 mm, their width (y-direction) is from 500 to 1250 mm, preferably from 500 to 900 mm, and their thickness (z-direction) is from 20 to 200 mm, preferably from 50 to 100 mm. It is moreover preferable that in the case of thermoplastic foam sheets having three or more layers each input sheet (thinner thermoplastic foam sheet) comprised therein has the abovementioned dimensions. In the case of three-layer thermoplastic foam sheets it is preferable that the two external input sheets have (exactly) the same thickness, while the central input sheet can optionally deviate in respect of its thickness from the corresponding thicknesses of the two external input sheets.

In one preferred embodiment of the present invention the thermoplastic foam sheet has three layers, and the thickness of the two thinner thermoplastic foam sheets which form the two external sheets in the three-layer thermoplastic foam sheet is identical. The expressions “external sheets of the three-layer thermoplastic foam sheets” and “exterior input sheet” therefore mean the two (initial) thinner thermoplastic foam sheets (input sheets) that respectively form one of the largest-area external sides of the three-layer thermoplastic foam sheet. The structure here is therefore what is known as a “sandwich structure” in which the two external sheets have not been directly bonded to one another but instead have been bonded by way of a third (central) thinner thermoplastic foam sheet (input sheet) therebetween. The two external sheets are therefore not in direct contact. The thickness (z-direction) of the central input sheet here can be as desired; it can therefore optionally have the same thickness as the two external sheets, or it can also have a smaller or greater thickness. It is preferable in this embodiment that the thickness of the central input sheet is at most 25% smaller than that of the two external sheets. The dimensions (length, width, and thickness) of the three input sheets preferably correspond to the dimensions stated in the preceding paragraph. It is particularly preferable that the thickness of each of the two exterior input sheets is from 70 to 90 mm, while the thickness of the central input sheet is from 50 to 70 mm, where the thickness of the central input sheet is always smaller than the thickness of the two external sheets. In a particularly preferred example here, the thickness of each of the two external sheets is 80 mm and the thickness of the central input sheet is 60 mm. It is moreover preferable in this embodiment that all of the input sheets are bonded to one another by symmetrical thermal welding.

It is moreover preferable in the invention that the thermally induced warpage of ≦1.5 mm remains constant for a period of at least one week.

It is moreover preferable in the invention that in the symmetrical bonding, preferably in the symmetrical thermal welding, in the case of at least one pair of sheets to be bonded, at least one, preferably both, surfaces to be bonded of the thinner thermoplastic foam sheets are foaming-skin-free.

It is moreover preferable in the process of the invention that the thinner thermoplastic foam sheet is an extruded foam and the polymer used for the extrusion process additionally comprises at least one component selected from a mineral filler, a nucleating agent, a flame retardant, or an IR absorber, and the polymer used for the extrusion process preferably comprises graphite as IR absorber.

It is moreover preferable that in processes of the invention the thin thermoplastic foam sheets that have been joined together and that are to be symmetrically bonded are subjected to a pressing process. The duration of the pressing process is generally in the range from seconds to minutes and/or the pressure in said process is generally from 0.1 to 0.5 bar. The pressing process in the invention preferably takes place after the symmetrical bonding, in particular after the symmetrical thermal welding. Insofar as the symmetrical thermal welding in the context of the present invention is carried out only by means of irradiation with electromagnetic radiation, the pressing process can also be carried out before the symmetrical thermal welding.

It is optionally possible in the process of the invention to carry out a drying step, for example after application of an absorber of electromagnetic radiation to the surface of the thinner thermoplastic foam sheets. The duration of the drying process is normally from 10 minutes to 2 hours, and/or the temperature therefor is normally in the range from 50 to 100° C.

The present invention further provides the thermoplastic foam sheets per se which have at least two layers and which can be produced by the process described above.

The invention is illustrated below with reference to examples.

The thermoplastic foam sheets (“sheets”) are produced in a continuous extruding process as described in “Polystyrol, Kunststoffhandbuch 4” [Polystyrene, Plastics handbook 4] [H. Gausepohl and R. Gellert, Hanser-Verlag, Munich (1996)], chapter 13.2.3 (pp. 591-598), in particular in the upper part of FIG. 13.24. In each case two input sheets (Styrodur 3035 CS, density 35 g/l, thickness 50 mm, size (length×width) 120×60 cm²) are bonded to one another 30 minutes after production thereof (by continuous extrusion); in inventive examples 2 and 3 here the symmetrical bonding of the two input sheets takes place by symmetrical thermal welding, whereas in comparative example 1 no symmetrical bonding of the two input sheets is carried out.

The experimental parameters set in the thermal welding process (not only in the symmetrical variant but also in the conventional variant) are as follows: the welding temperature is 180° C., the welding time is 5 seconds, and the pressure applied is 0.01 N/mm². The experiments use a commercially available SMS 203 hotplate welding system from Wegener GmbH.

After the thermal welding, the resultant two-layer thermoplastic foam sheets are stored for 48 hours at room temperature and then for 12 hours at 60° C. in a drying oven. Deformation (thermally induced warpage) is measured immediately after the heat-aging and after one week of storage. Deformation is determined as maximal deviation in relation to a horizontally placed leveling rod.

TABLE 1

| | | Max. | |
|---|---|---|---|
| | | deformation | Max. |
| | | after 12 hours | deformation |
| Exam- | | of heat-aging | after 7 days |
| ple | Method | (mm) | (mm) |
| 1 | Sheets were welded, lower side | 2 | 4 |
| (comp.) | to upper side, 30 minutes after | | |
| | production | | |
| 2 | Sheets were welded, lower side | 1 | 1 |
| | to lower side, 30 minutes after | | |
| | production | | |
| 3 | Sheets were welded, upper side | 1 | 1 |
| | to upper side, 30 minutes after | | |
| | production | | |

comp.: comparative example

The above experiments in table I show that by symmetrical bonding (specifically: symmetrical thermal welding) it is possible to produce the thermoplastic foam sheets of the invention with reduced thermally induced warpage. Whereas in the two inventive examples 2 and 3 the respective input sheets were bonded to one another symmetrically, either lower side to lower side (inventive example 2) or upper side to upper side (inventive example 3), bonding of the two input sheets in comparative example 1 was asymmetrical, the lower side of the first input sheet having been thermally welded to the upper side of the second input sheet (conventionally).

Two-layer thermoplastic foam sheets of the invention are those whose maximal deformation (thermally induced warpage) after heat-aging—following sheet production—is ≦1.5 mm. The heat-aging moreover does not cause any thermal degradation of the surface of the sheet (extrusion skin), but instead the surface of the sheet is smooth not only before but also after the heat-aging. In the case of the extruded thermoplastic foam sheets of the invention moreover the abovementioned limiting deformation value of 1.5 mm is found not to be exceeded even after at least one week of storage.

1.-16. (canceled)

17. A process for the production of an at least two-layer thermoplastic foam sheet, the process comprising symmetrically bonding at least two thin thermoplastic foam sheets to provide the at least two-layer thermoplastic foam sheet.

18. The process according to claim 17, wherein the at least two-layer thermoplastic foam sheet is a two-layer or three-layer, thermoplastic foam sheet.

19. The process according to claim 18, wherein the thermoplastic foam sheet is a two-layer thermoplastic foam sheet.

20. The process according to claim 17, wherein the at least two-layer thermoplastic foam sheet is an extruded foam sheet, the thermally induced warpage of which is ≦1.5 mm, based on the thickness of the at least two-layer extruded thermoplastic foam sheet.

21. The process according to claim 17, wherein the symmetrical bonding is conducted by symmetrical adhesive bonding or symmetrical thermal welding.

22. The process according to claim 17, wherein the symmetrical bonding where at least one pair of sheets is to be bonded comprises bonding either two upper sides or two lower sides of the respective thinner thermoplastic foam sheets to one another.

23. The process according to claim 17, wherein, in the symmetrical bonding where at least one pair of sheets is to be bonded, the density of the respective surfaces to be bonded of the two thinner thermoplastic foam sheets is identical or differs by at most 20%.

24. The process according to claim 17, wherein the symmetrical bonding is conducted by symmetrical thermal welding, and the thickness of the weld formed is from 30 μm to 200 μm.

25. The process according to claim 24, wherein the thickness of the weld is from 80 μm to 100 μm.

26. The process according to claim 17, wherein the at least two thin thermoplastic foam sheets is a molded foam or an extruded foam.

27. The process according to claim 26, wherein the extruded foam is made of polystyrene or a styrene copolymer.

28. The process according to claim 17, wherein the thermoplastic foam sheet comprises at least one flame retardant selected from the group consisting of a phosphate, a phosphite, a phosphonate, a polyphosphonate, melamine, an aluminum oxide hydrate, and a halogenated organic compound.

29. The process according to claim 17, wherein one sheet of a pair of thin thermoplastic foam sheets to be symmetrically bonded includes a bonding surface that is foaming-skin-free.

30. The process according to claim 17, both sheets of a pair of thin thermoplastic foam sheets to be symmetrically bonded includes a bonding surface that is foaming-skin-free.

31. The process according to claim 17, wherein the symmetrical bonding is conducted with symmetrical thermal welding carried out at temperatures of from 50 to 300° C. above the glass transition temperature for amorphous thermoplastic foams, or at temperatures of from 50 to 100° C. above the melting point for semicrystalline thermoplastic foams.

32. The process according to claim 17, wherein the at least one pair of sheets to be symmetrically bonded, the length (x-direction) of each of the two thin thermoplastic foam sheets is from 500 to 2800 mm, the width (y-direction) is from 500 to 1250 mm, and the thickness (z-direction) is from 20 to 200 mm.

33. The process according to claim 17, wherein the thermally induced warpage of ≦1.5 mm remains constant for a period of at least one week.

34. The process according to claim 17, wherein the thin thennoplastic foam sheet is an extruded foam, and the polymer used for the extrusion process comprises at least one component selected from a mineral filler, a nucleating agent, a flame retardant, or an IR absorber.

35. The process according to claim 17, wherein the thin thermoplastic foam sheet is an extruded foam, and the polymer used for the extrusion process comprises graphite as an IR absorber.

36. The process according to claim 17, wherein the thermoplastic foam sheet has three layers, and the at least two thin thermoplastic foam sheets provide two external sheets with equal thickness in the three-layer thermoplastic foam sheet.

37. A thermoplastic foam sheet with at least two layers and is produced by a process according to claim 17.
